(19) United States
(12) Patent Application Publication
(10) Pub. No.: US 2026/0320091 A1
(43) Pub. Date: Oct. 15, 2026

(54) Automated Workflow Generation for Objective Optimization

(71) Applicant: ZenLeads Inc., Covina, CA (US)

(72) Inventors: Golam Azam Abbasy, Austin, TX (US); Timothy Marks, Costa Mesa, CA (US); Yu Jia Chiao, Brea, CA (US); Clara Lee, Brisbane, CA (US)

(21) Appl. No.: 19/647,771

(22) Filed: Apr. 14, 2026

Related U.S. Application Data
(60) Provisional application No. 63/789,353, filed on Apr. 15, 2025.

(51) Int. Cl. G06F 16/3329; H04L 51/02

(52) U.S. Cl. CPC G06F 16/33295; H04L 51/02

(57) ABSTRACT

An online system generates an automated workflow based on a user request that optimizes for an objective. The online system receives free text instructions from a user through a chat interface, where the instructions describe a workflow in natural language. The system identifies an objective comprising one or more metrics to be optimized by the workflow. The system generates a workflow generation prompt to a generative language model based on the free text instructions and objective, where the prompt includes candidate stage types such as data access, filtering, transformation, and output stages. The system receives a response from the generative language model containing workflow stages and selects parameters for each stage based on the objective and instructions. The system generates computer-executable instructions for the workflow using stage templates and executes the workflow in response to triggering events.

### CROSS-REFERENCE TO RELATED APPLICATIONS

This application claims the benefit of U.S. Provisional Application No. 63/789,353, filed Apr. 15, 2025, which is incorporated by reference.

### BACKGROUND

Online computer systems execute workflows to automate complex data processing and business operations. A workflow is a sequence of interconnected stages that process input data through various transformations to produce desired outputs. These workflows may include stages for data retrieval from databases or external systems, data filtering and validation, format conversions, statistical calculations, machine learning model applications, and result storage or transmission.

Traditionally, workflows require sophisticated engineers with specialized technical knowledge to design and implement. Engineers must understand the specific requirements of each workflow stage, configure appropriate parameters for data sources and processing operations, and ensure proper integration between different system components. This process involves writing custom code, configuring database connections, setting up data transformation rules, and establishing error handling procedures. The complexity of workflow creation often requires significant time investment and technical expertise, limiting the ability of non-technical users to generate automated workflows for their specific operational needs. Additionally, modifying existing workflows or creating new ones typically requires engineering resources and may involve lengthy development cycles that delay implementation of needed automation solutions.

### SUMMARY

An online system generates an automated workflow based on a user request that optimizes for an objective. The online system receives free text instructions from a user that describe a workflow for the online system to generate. The online system identifies an objective for optimization, where the objective includes one or more metrics to be optimized by the workflow. The online system generates a workflow generation prompt to a generative language model to generate stages of the workflow based on the free text instructions and the objective. The workflow generation prompt may include candidate stage types that can be used to perform the workflow, where each stage type specifies input requirements, output formats, and how input is transformed into output. The online system applies the generative language model to the prompt and receives a response with a set of workflow stages. The online system extracts the set of workflow stages from the response and identifies a workflow stage for each of the steps. The online system selects a set of parameters for each of the workflow stages based on the objective and the free text instructions. The parameters may specify input data sources, processing configurations, and output destinations for each stage. The online system generates the workflow based on the workflow stages and the selected parameters, creating computer-executable instructions for workflow execution.

The online system provides significant benefits by enabling non-technical users to create complex automated workflows through natural language instructions rather than requiring specialized programming knowledge. The system reduces the time and technical expertise needed for workflow creation by automatically generating appropriate workflow stages and parameters based on user objectives. The automated workflow generation eliminates the need for manual coding and configuration, making workflow automation accessible to a broader range of users and reducing development cycles for implementing needed automation solutions.

### BRIEF DESCRIPTION OF THE DRAWINGS

FIG. 1 illustrates an example system environment for an online system, in accordance with some embodiments.

FIG. 2 is a flowchart for a method of generating workflows for execution in an online system based on free text instructions from users, in accordance with some embodiments.

FIG. 3 illustrates an example user interface through which a user may generate a workflow, in accordance with some embodiments.

FIG. 4 illustrates an example data flow for generating computer-executable instructions for a workflow, in accordance with some embodiments.

### DETAILED DESCRIPTION

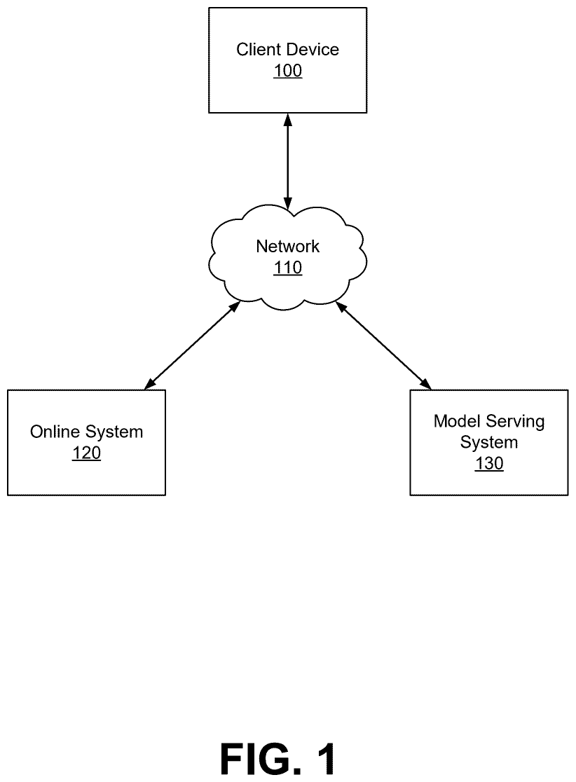

FIG. 1 illustrates an example system environment for an online system 120, in accordance with one or more embodiments. The system environment illustrated in FIG. 1 includes a client device 100, a network 110, an online system 120, and a model serving system 130. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The user client device 100 is a client device through which a user may interact with the online system 120. The client device 100 can be a personal or mobile computing device, such as a smartphone, a tablet, a laptop computer, or desktop computer. In some embodiments, the user client device 100 executes a client application that uses an application programming interface (API) to communicate with the online system 120.

The user client device 100, the online system 120, and the model serving system 130 can communicate with each other via the network 110. The network 110 is a collection of computing devices that communicate via wired or wireless connections. The network 110 may include one or more local area networks (LANs) or one or more wide area networks (WANs). The network 110, as referred to herein, is an inclusive term that may refer to any or all of the standard layers used to describe a physical or virtual network, such as the physical layer, the data link layer, the network layer, the transport layer, the session layer, the presentation layer, and the application layer. The network 110 may include physical media for communicating data from one computing device to another computing device, such as multiprotocol label switching (MPLS) lines, fiber optic cables, cellular connections (e.g., 3G, 4G, or 5G spectra), or satellites. The network 110 also may use networking protocols, such as TCP/IP, HTTP, SSH, SMS, or FTP, to transmit data between computing devices. In some embodiments, the network 110 may include Bluetooth or near-field communication (NFC) technologies or protocols for local communications between computing devices. The network 110 may transmit encrypted or unencrypted data.

The model serving system 130 receives requests from the online system 120 to perform tasks using machine-learned models. The tasks include, but are not limited to, natural language processing (NLP) tasks, audio processing tasks, image processing tasks, video processing tasks, and the like. In one embodiment, the machine-learned models deployed by the model serving system 130 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model is coupled to receive sequential data tokenized into a sequence of input tokens and generates a sequence of output tokens depending on the task to be performed.

The model serving system 130 receives a request including input data (e.g., text data, audio data, image data, or video data) and encodes the input data into a set of input tokens. The model serving system 130 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 120 or one or more entities different from the online system 120. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one embodiment, the task for the model serving system 130 is based on knowledge of the online system 120 that is fed to the machine-learned model of the model serving system 130, rather than relying on general knowledge encoded in the model weights of the model. Thus, one objective may be to perform various types of queries on the external data in order to perform any task that the machine-learned model of the model serving system 130 could perform. For example, the task may be to perform question-answering, text summarization, text generation, and the like based on information contained in an external dataset.

Thus, in one embodiment, the online system 120 is connected to an interface system. The interface system receives external data from the online system 120 and builds a structured index over the external data using, for example, another machine-learned language model or heuristics. The interface system receives one or more queries from the online system 120 on the external data. The interface system constructs one or more prompts for input to the model serving system 130. A prompt may include the query of the user and context obtained from the structured index of the external data. In one instance, the context in the prompt includes portions of the structured indices as contextual information for the query. The interface system obtains one or more responses from the model serving system and synthesizes a response to the query on the external data. While the online system 120 can generate a prompt using the external data as context, often times, the amount of information in the external data exceeds prompt size limitations configured by the machine-learned language model. The interface system can resolve prompt size limitations by generating a structured index of the data and offers data connectors to external data sources.

The example system environment in FIG. 1 illustrates an environment where the model serving system 130 is managed by a separate entity from the online system 120. However, in alternative embodiments, the model serving system 130 (or the interface system) is part of the online system 120.

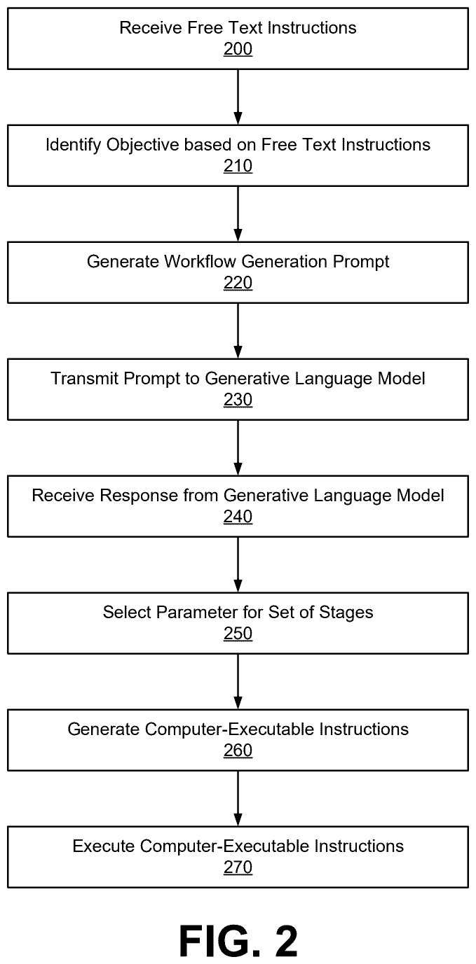

FIG. 2 is a flowchart for a method of generating workflows for execution in an online system based on free text instructions from users, in accordance with some embodiments. Alternative embodiments may include more, fewer, or different steps from those illustrated in FIG. 2, and the steps may be performed in a different order from that illustrated in FIG. 2. These steps may be performed by an online system (e.g., online system 120). Additionally, each of these steps may be performed automatically by the online system without human intervention.

The online system receives 200 free text instructions from a user to generate a workflow. Free text instructions are natural language explanations of an automated workflow for the online system to generate. For example, a user may provide free text instructions such as “Create a workflow that processes sensor data from IoT devices and generates automated system diagnostics.” The free text instructions may specify various aspects of the automated workflow. For example, the free text instructions may specify input data sources for the workflow, such as databases, files, or external systems from which the workflow should retrieve data. The free text instructions also may specify output formats or destinations where the workflow should store or transmit results. The free text instructions may specify locations of input data or output data, such as file paths, database tables, or network addresses. In some embodiments, the free text instructions may specify processing steps or transformations that the workflow should perform on the input data. For example, the free text instructions may specify “filter out records with missing temperature values, calculate daily averages for each sensor, and apply anomaly detection algorithms to identify unusual patterns.”

The online system may receive the free text instructions through a chat interface. The chat interface may be part of a broader user interface where a main portion displays other information. For example, the chat interface may appear as a sidebar or overlay while the main portion shows pages of a webpage through which the user interfaces with the online system. The main portion may display dashboards, data visualizations, or configuration settings related to existing workflows or system operations. The chat interface may include text input fields, message history displays, and interactive elements for submitting the free text instructions.

The online system may prompt the user for more information through the chat interface. For example, a generative language model may evaluate the chat history and identify whether the online system has sufficient information for generating the automated workflow. The generative language model may analyze the free text instructions to identify missing or ambiguous specifications. The generative language model may generate follow-up questions through the chat interface to clarify workflow requirements. The online system may request additional details about data sources, processing parameters, or output specifications. The online system may present options or suggestions to the user through the chat interface to help complete the workflow specification.

The online system identifies 210 an objective for optimization. An objective is one or more metrics to be optimized by the workflow. The online system may maximize or minimize the metrics based on the workflow requirements. When the objective includes more than one metric, the objective may include weightings for the different metrics that reflect a relative importance each metric.

The metrics for the objective may be one of a set of candidate metrics. For example, the online system may store a set of candidate metrics for use by the online system to select from when identifying metrics for the objective. The candidate metrics may include performance measures such as execution time, resource utilization, data throughput, accuracy rates, or cost metrics. The online system may maintain this set of candidate metrics in a database or configuration file accessible during workflow generation.

In some embodiments, the user selects the objective from a list of candidate metrics through a user interface with an element for each objective. For example, the user interface may present checkboxes, dropdown menus, or selection buttons corresponding to each available metric. The user may specify weights or priority levels for selected metrics through input fields or slider controls. The online system may receive the user selections through user interface elements in the chat interface.

The online system identifies the objective using a generative language model. The online system generates a prompt to the generative language model to identify one or more metrics based on the free text instructions. The prompt may include a candidate set of metrics for the objective from which the generative language model may select. The prompt may include guidance for how to select from the candidate set. The guidance may specify criteria for metric selection based on workflow characteristics, data types, or processing requirements.

The online system may also include, in the prompt to the generative language model, data associated with the user to identify the objective. For example, the online system may include data describing the user such as user preferences, historical workflow patterns, or role-based permissions. The online system may also use data stored by the online system on behalf of the user or an organization associated with the user. For example, the user may be an agent of an organization or otherwise associated with an organization and the online system may store data on behalf of the organization. In some embodiments, the online system is a customer relationship management system and the online system stores information about customers of the user or the user's organization. The online system may use data or metadata stored on behalf of the user or organization in the prompt to help the generative language model understand the context and requirements for objective identification.

The online system generates 220 a workflow generation prompt based on the identified objective. A workflow generation prompt is a prompt to a generative language model to generate stages of the workflow. The prompt includes the identified objective and instructs the generative language model to generate a set of stages for a workflow for optimizing the objective. The prompt may further include information describing input data for the workflow. The prompt may include output values or format specifications for the workflow results. The prompt may include the free text instructions from the user to provide context for workflow generation.

The workflow generation prompt may include candidate stage types that can be used to perform the workflow. Example candidate stage types include data access stages for retrieving information from databases or external systems, data filtering stages for removing unwanted records, data transformation stages for converting between formats, aggregation stages for calculating summaries or statistics, machine learning stages for applying predictive models, and output stages for storing or transmitting results to specified destinations. Each stage type may specify input requirements for the stage. Each stage type may specify output formats produced by the stage. Each stage type may specify how the input is transformed into output during stage execution. The stage types may include parameters that can be set for the stage. The parameters may control the behavior and configuration of each stage type during workflow execution.

The candidate stage types may correspond to stage templates stored by the online system. These stage templates have computer executable instructions for executing a stage in a workflow. The online system can set parameters for the stage template for use in production. The online system may configure the stage templates with specific parameter values to configure their behavior for particular workflow requirements. The parameters may include specifications for what input data to use for each stage, the location of input data such as file paths, database connections, or network endpoints, optional sub processes that may be performed within the stage, specifications for where to store output data from the stage, and an identifier for next stages to execute in the workflow sequence.

The online system transmits 230 the workflow generation prompt to the generative language model. The online system may send the prompt through an application programming interface or network connection to the model serving system. The online system may include authentication credentials or session tokens with the prompt transmission. The online system may specify processing parameters such as response format requirements or generation constraints when transmitting the prompt.

The online system receives 240 a response from the generative language model with a set of workflow stages. The response may include structured data that specifies each workflow stage in the generated workflow. The online system may parse the response to extract the workflow stages from the generative language model output. The online system may validate the received workflow stages against the candidate stage types to ensure compatibility with the system's execution capabilities.

The online system selects 250 a set of parameters for each of the workflow stages. In some embodiments, the response from the generative language model includes the parameters for each of the workflow stages. The generative language model may generate both the workflow stages and their corresponding parameter values in a single response. The online system may extract the parameters directly from the generative language model response when they are included.

Alternatively, the online system may separately prompt to generate parameters for each of the workflow stages. For example, the online system may generate a parameter generation prompt that instructs the generative language model to generate parameters for each of the generated stages. A parameter generation prompt includes the stages generated for the workflow and instructions to generate parameters for each of the stages. The parameter generation prompt may include a list of parameters for each stage and instructions for how to select parameters.

For example, the parameter generation prompt may specify how different parameter values impact the execution of the stage. The online system may provide descriptions of how parameter modifications affect stage performance, resource utilization, or output characteristics. In some cases, the instructions specify a set of candidate parameters from which the generative language model should select for some or all of the parameters. The online system may only provide candidate parameter sets for a subset of parameters. For example, the online system may not provide candidate parameters for parameters that specify where data is located or where data should be stored.

The parameter generation prompt may include user data or organization data associated with the user. For example, the online system may use data describing the user such as user preferences, historical workflow patterns, or role-based permissions. The online system may also use data stored by the online system on behalf of the user or an organization associated with the user. The online system may include data or metadata describing available data sources in the parameter generation prompt to help the generative language model select appropriate parameter values for data access and storage locations.

The online system generates 260 a workflow based on the workflow stages and the set of parameters for each of the workflow stages. The online system generates computer-executable instructions for the workflow based on the stages. For example, the online system may use computer-executable instructions from templates for workflow stages to generate computer-executable instructions for the full workflow. The online system may retrieve the stage templates corresponding to each workflow stage identified in the previous steps. The online system may instantiate each stage template with the selected parameters to create configured workflow components.

The online system may store computer-executable instructions for the workflow as a separate set of instructions. Alternatively, the online system may store data that specify how the computer-executable instructions from the template workflows should be used to execute the workflow. For example, the online system may store the selected parameters along with references to the stage templates rather than generating a complete set of executable instructions. The online system may store workflow configuration data that includes stage identifiers, parameter values, and execution sequence information. The online system may store this workflow data in a database, file system, or other persistent storage mechanism accessible during workflow execution.

The online system executes 270 the workflow using the computer-executable instructions. The online system may execute the workflow in response to events that trigger the execution. For example, the online system may initiate workflow execution when new data becomes available, when scheduled time intervals occur, or when external systems send execution requests. The online system may execute the workflow regularly according to predefined schedules or intervals. The online system may monitor for triggering conditions and automatically start workflow execution when those conditions are met.

Executing the workflow may include using parameters from stages of the workflow to identify input data for the workflow. The online system may retrieve parameter values that specify data source locations, file paths, or database connection details. The online system may use these parameters to access the appropriate input data required by each workflow stage. The online system may validate that the specified input data sources are accessible and contain the expected data formats before proceeding with execution.

The online system also may identify an output location for the workflow and store output there. The online system may use parameters that specify where to store workflow results, such as database tables, file directories, or external system endpoints. The online system may create the necessary storage structures or connections if they do not already exist. The online system may format the workflow output according to the specified requirements before storing it at the designated location.

The workflow may be executed multiple times for different sets of input data. The online system may process various input datasets using the same workflow configuration and parameters. The online system may maintain separate execution instances for each input dataset to avoid conflicts between concurrent executions. The online system may track the execution status and results for each workflow run to provide monitoring and logging capabilities.

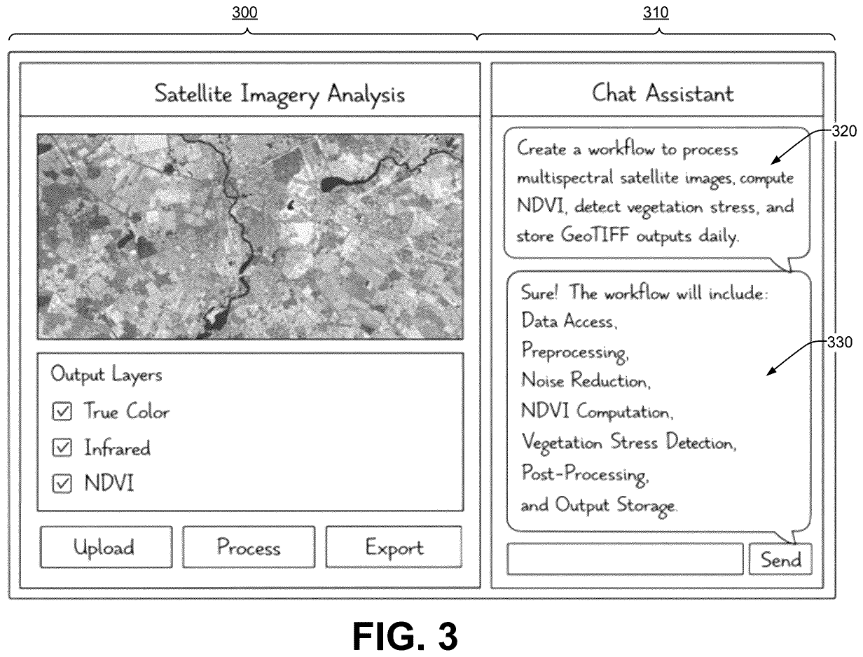

FIG. 3 illustrates an example user interface through which a user may generate a workflow, in accordance with some embodiments. The user interface includes a main user interface portion 300 and a chat user interface portion 310. The user can provide free text instructions 320 for generating a workflow and the online system generates the stages for the workflow as described above. In some embodiments, the online system responds by listing the stages 330 in the chat user interface for review and confirmation by the user.

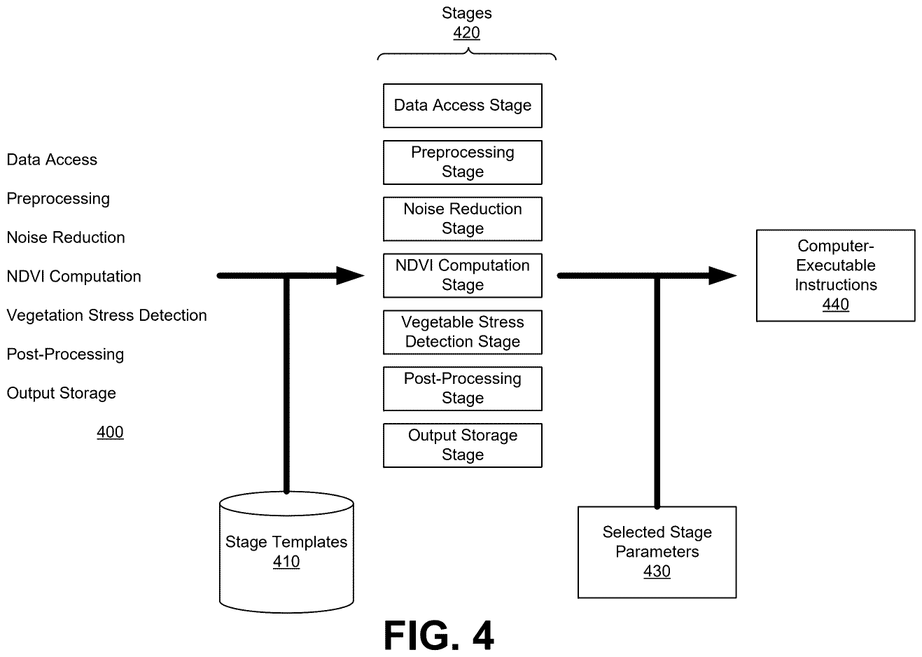

FIG. 4 illustrates an example data flow for generating computer-executable instructions for a workflow, in accordance with some embodiments. In response to a workflow generation prompt, a generative language model generates an output 400 that describes a set of stages to be executed to optimize an objective in a user's free text instructions. The online system may use stage templates 410 to generate the stages 420 for execution for the workflow. The online system uses selected stage parameters 430 for the generates stages to generate the computer-executable instructions 440 for the workflow.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method comprising:
receiving, at an online system, free text instructions from a client device through a chat user interface, wherein free text instructions includes natural language instructions describing a workflow to be executed by the online system;
identifying an objective based on the free text instructions, wherein the objective comprises a metric to be optimized through execution of the workflow;
generating a workflow generation prompt based on the free text instructions and the identified objective, wherein the workflow generation prompt is a prompt to a generative language model to generate a set of stages for the workflow based on the free text instructions and the objective, wherein each workflow stage has corresponding set of parameters;
transmitting workflow generation prompt to the generative language model;
receiving a response from the generative language model, wherein the response comprises the set of stages for the workflow;
selecting a parameter for each of the set of stages for the workflow based on the identified objective and the free text instructions;
generating computer-executable instructions for the workflow based on the set of stages and the parameter for each of the set of stages; and
executing the computer-executable instructions for the workflow.

2. The method of claim 1, wherein the chat user interface is displayed on the user client device concurrently with a main user interface portion.

3. The method of claim 1, wherein receiving the free text instructions comprises:
transmitting a prompt to the generative language model to generate a follow-up question based on initial free text instructions received from the user client device;
receiving a response to the prompt from the generative language model, wherein the response comprises a follow-up question; and
transmitting the follow-up question to the client device for display to the user through the chat user interface.

4. The method of claim 1, wherein identifying the objective comprises:
selecting the metric from a set of candidate metrics stored by the online system.

5. The method of claim 1, wherein identifying the objective comprises:
identifying a plurality of metrics and corresponding weight values indicating relative importance of each metric of the plurality of metrics.

6. The method of claim 1, wherein identifying the objective comprises generating an objective identification prompt to the generative language model, the prompt including a candidate set of metrics and selection guidance.

7. The method of claim 1, wherein the workflow generation prompt further includes a set of candidate stage types and instructions for the generative language model to generate the set of stages by selecting from the set of candidate stage types.

8. The method of claim 7, wherein each candidate stage type corresponds to a stored stage template comprising computer-executable instructions for executing a stage of the corresponding stage type and a parameter for configuring the executing of the stage of the corresponding stage type.

9. The method of claim 1, wherein selecting the parameter for each of the set of stages comprises:
transmitting a parameter generation prompt to the generative language model, wherein the parameter generation prompt comprises the identified objective and the set of stages and instructions for the generative language model to select a parameter for each of the set of stages.

10. The method of claim 9, wherein the parameter generation prompt further comprises, for each of the set of stages, a set of candidate parameter values and instructions for the generative language model to select a candidate parameter value from the set of candidate parameter values for each of the set of stages.

11. A non-transitory computer-readable medium storing computer-executable instructions that, when executed, cause a computing system to perform operations comprising:
receiving, at an online system, free text instructions from a client device through a chat user interface, wherein free text instructions includes natural language instructions describing a workflow to be executed by the online system;
identifying an objective based on the free text instructions, wherein the objective comprises a metric to be optimized through execution of the workflow;
generating a workflow generation prompt based on the free text instructions and the identified objective, wherein the workflow generation prompt is a prompt to a generative language model to generate a set of stages for the workflow based on the free text instructions and the objective, wherein each workflow stage has corresponding set of parameters;
transmitting workflow generation prompt to the generative language model;
receiving a response from the generative language model, wherein the response comprises the set of stages for the workflow;
selecting a parameter for each of the set of stages for the workflow based on the identified objective and the free text instructions;
generating computer-executable instructions for the workflow based on the set of stages and the parameter for each of the set of stages; and
executing the computer-executable instructions for the workflow.

12. The computer-readable medium of claim 11, wherein the chat user interface is displayed on the user client device concurrently with a main user interface portion.

13. The computer-readable medium of claim 11, wherein receiving the free text instructions comprises:
transmitting a prompt to the generative language model to generate a follow-up question based on initial free text instructions received from the user client device;
receiving a response to the prompt from the generative language model, wherein the response comprises a follow-up question; and
transmitting the follow-up question to the client device for display to the user through the chat user interface.

14. The computer-readable medium of claim 11, wherein identifying the objective comprises:
selecting the metric from a set of candidate metrics stored by the online system.

15. The computer-readable medium of claim 11, wherein identifying the objective comprises:
identifying a plurality of metrics and corresponding weight values indicating relative importance of each metric of the plurality of metrics.

16. The computer-readable medium of claim 11, wherein identifying the objective comprises generating an objective identification prompt to the generative language model, the prompt including a candidate set of metrics and selection guidance.

17. The computer-readable medium of claim 11, wherein the workflow generation prompt further includes a set of candidate stage types and instructions for the generative language model to generate the set of stages by selecting from the set of candidate stage types.

18. The computer-readable medium of claim 17, wherein each candidate stage type corresponds to a stored stage template comprising computer-executable instructions for executing a stage of the corresponding stage type and a parameter for configuring the executing of the stage of the corresponding stage type.

19. The computer-readable medium of claim 11, wherein selecting the parameter for each of the set of stages comprises:
transmitting a parameter generation prompt to the generative language model, wherein the parameter generation prompt comprises the identified objective and the set of stages and instructions for the generative language model to select a parameter for each of the set of stages.

20. The computer-readable medium of claim 19, wherein the parameter generation prompt further comprises, for each of the set of stages, a set of candidate parameter values and instructions for the generative language model to select a candidate parameter value from the set of candidate parameter values for each of the set of stages.
